(19) United States
(12) Patent Application Publication
(10) Pub. No.: US 2024/0064875 A1
(43) Pub. Date: Feb. 22, 2024

(54) INDUCTION HEATING APPARATUS

(71) Applicant: SAMSUNG ELECTRONICS CO., LTD., Suwon-si (KR)

(72) Inventors: Hongjoo KANG, Suwon-si (KR); Eundae BAE, Suwon-si (KR); Myoungjin HAM, Suwon-si (KR)

(21) Appl. No.: 18/214,585

(22) Filed: Jun. 27, 2023

Related U.S. Application Data
(63) Continuation of application No. PCT/KR23/07388, filed on May 30, 2023.

(30) Foreign Application Priority Data
Aug. 17, 2022 (KR) 10-2022-0102984
Oct. 27, 2022 (KR) 10-2022-0140715

(51) Int. Cl. H05B 6/06; H05B 6/12; H05B 6/04

(52) U.S. Cl. CPC H05B 6/062; H05B 6/1209; H05B 6/04

(57) ABSTRACT

Provided is an induction heating apparatus capable of satisfying a rated voltage without a circuit change, the induction heating apparatus including: a circuit configuration including a first node, a second node, a third node, and a fourth node, a power supply module having a first terminal and a second terminal, a first bypass part formed between the first terminal and the first node, a second bypass part formed between the first node and the second node, a third bypass part formed between the first node and the third node, a first switching element connected to the second node and the third node, a second switching element connected to the third node and the second terminal, and a heating coil connected between the third node and the fourth node.

### CROSS-REFERENCE TO RELATED APPLICATION(S)

This application is a continuation application, claiming priority under § 365(c), of an International application No. PCT/KR2023/007388, filed on May 30, 2023, which is based on and claims the benefit of a Korean patent application number 10-2022-0102984, filed on Aug. 17, 2022 and Korean patent application number 10-2022-0140715 filed on Oct. 27, 2020, in the Korean Intellectual Property Office, the disclosure of which is incorporated by reference herein in its entirety.

### TECHNICAL FIELD

The disclosure relates to an induction heating apparatus capable of satisfying a rated voltage without changing a circuit.

### BACKGROUND

In general, an induction heating apparatus is a cooking apparatus that heats and cooks food using the principle of induction heating. An induction heating apparatus includes a cooking plate on which a cooking vessel is placed, and a heating coil that generates a magnetic field when current is applied thereto.

When a current is applied to the heating coil and a magnetic field is generated, a secondary current is induced in the cooking vessel, and Joule heat is generated by a resistance component of the cooking vessel itself. Therefore, the cooking vessel is heated by the high-frequency current and the food contained in the cooking vessel is cooked.

The induction heating apparatus, which uses a cooking vessel itself as a heat source, has a higher heat transfer rate as compared to a gas range or a kerosene stove. Moreover, unlike a gas range and a kerosene stove that burns fossil fuel and heats a cooking vessel through the heat of combustion, the induction heating apparatus generates no harmful gas and thereby lowers a risk of fire.

Since different rated voltages are used for each country, the specifications of heating coils are set to correspond to the rated voltage when manufacturing induction heating apparatuses.

### SUMMARY

One aspect of the disclosure provides a method of manufacturing an induction heating apparatus capable of adapting to a rated voltage without changing a circuit configuration.

One aspect of the disclosure provides an induction heating apparatus capable of adapting to a rated voltage without changing a circuit configuration.

A method of manufacturing an induction heating apparatus according to one aspect of the disclosure, which is an induction heating apparatus including a circuit configuration including: a first node, a second node, a third node, and a fourth node; a power supply module having a first terminal and a second terminal; a first bypass part formed between the first terminal and the first node; a second bypass part formed between the first node and the second node; a third bypass part formed between the first node and the third node; a first switching element connected to the second node and the third node; a second switching element connected to the third node and the second terminal; and a heating coil connected between the third node and the fourth node, includes manufacturing a first induction heating apparatus corresponding to a first rated voltage by connecting an inductor element to the first bypass part and connecting a jumper element to the third bypass part and manufacturing a second induction heating apparatus corresponding to a second rated voltage by connecting a jumper element to the first bypass part and connecting a jumper element to the second bypass part.

In addition, the first rated voltage may be lower than the second rated voltage.

In addition, the circuit configuration may include a first capacitor connected to the second node and the fourth node, and a second capacitor connected to the fourth node and the second terminal.

In addition, the circuit configuration may further include a third capacitor connected to the second node and the second terminal.

In addition, the manufacturing of the second induction heating apparatus may further include removing the third capacitor from the circuit configuration.

In addition, the circuit configuration may be formed on a printed circuit board.

In addition, the printed circuit board may include at least one visual indicator for guiding the method of manufacturing the first induction heating apparatus.

In addition, the printed circuit board may include at least one visual indicator for guiding the method of manufacturing the second induction heating apparatus.

In addition, the power supply module may include a rectifier connected to an alternating current (AC) power supply, and the first terminal may be supplied with a direct current (DC) voltage rectified by the rectifier.

In addition, the second terminal may be connected to a ground node.

An induction heating apparatus according to one aspect of the disclosure includes a circuit configuration including: a first node, a second node, a third node, and a fourth node; a power supply module having a first terminal and a second terminal; a first bypass part formed between the first terminal and the first node; a second bypass part formed between the first node and the second node; a third bypass part formed between the first node and the third node; a first switching element connected to the second node and the third node; a second switching element connected to the third node and the second terminal; and a heating coil connected between the third node and the fourth node, wherein according to a rated voltage of the power supply module, one of an inductor element and a first jumper element is configured to be connected to the first bypass part, and a second jumper element is configured to be connected to one selected from the second bypass part and the third bypass part.

The rated voltage may be a first rated voltage or a second rated voltage, and the first rated voltage may be lower than the second rated voltage.

In response to the rated voltage being the first rated voltage, the inductor element may be configured to be connected to the first bypass part, and the second jumper element may be configured to be connected to the third bypass part from between the first node and the third node.

In response to the rated voltage being the second rated voltage, the first jumper element may be configured to be connected to the first bypass part, and the second jumper element may be configured to be connected to the second bypass part from between the first node and the second node.

The induction heating apparatus may further include: a first capacitor connected to the second node and the fourth node; and a second capacitor connected to the fourth node and the second terminal.

The circuit configuration may selectively include a third capacitor configured to connect the second node to the second terminal according to the rated voltage of the power supply module.

In response to the rated voltage being the first rated voltage, the circuit configuration may include the third capacitor, and in response to the rated voltage being the second rated voltage greater than the first rated voltage, the circuit configuration may exclude the third capacitor.

The circuit configuration may be med on a printed circuit board (PCB).

The PCB may include at least one visual indicator for guiding a method of manufacturing the induction heating apparatus corresponding to the rated voltage.

The power supply module may include a rectifier connected to an alternating current (AC) power supply, and a direct current (DC) voltage rectified by the rectifier may be applied to the first terminal.

The second terminal may be connected to a ground node.

An induction heating apparatus according to one aspect of the disclosure includes: a first node, a second node, a third node, and a fourth node; a power supply module having a first terminal and a second terminal; an inductor element connected to the first terminal and the first node; a jumper element connecting the first node to the third node; a first switching element connected to the second node and the third node; a second switching element connected to the third node and the second terminal; a heating coil connected between the third node and the fourth node; a first capacitor connected to the second node and the fourth node; a second capacitor connected to the fourth node and the second terminal; and a third capacitor connected to the second node and the second terminal.

An induction heating apparatus according to one aspect of the disclosure includes: a first node, a second node, a third node, and a fourth node; a power supply module having a first terminal and a second terminal; a first jumper element connecting the first terminal to the first node; a second jumper element connecting the first node to the second node; a first switching element connected to the second node and the third node; a second switching element connected to the third node and the second terminal; a heating coil connected between the third node and the fourth node; a first capacitor connected to the second node and the fourth node; and a second capacitor connected to the fourth node and the second terminal.

An induction heating apparatus according to one aspect of the disclosure includes: a first node, a second node, a third node, and a fourth node; a power supply module having a first terminal and a second terminal; an inductor element connected to the first terminal and the first node; a first switch selectively connecting the first node to the second node; a second switch selectively connecting the first node to the third node; a first switching element connected to the second node and the third node; a second switching element connected to the third node and the second terminal; a heating coil connected between the third node and the fourth node; a first capacitor connected to the second node and the fourth node; a second capacitor connected to the fourth node and the second terminal; a third capacitor connected to the second node and the second terminal; a voltage detector configured to detect an output voltage of the power supply module; and a controller configured to control the first switch and the second switch based on a magnitude of the voltage detected by the voltage detector.

In addition, the controller may be configured to: open the first switch and close the second switch based on the magnitude of the voltage detected by the voltage detector being smaller than a reference value.

In addition, the controller may be configured to close the first switch and open the second switch based on the magnitude of the voltage detected by the voltage detector being greater than the reference value.

In addition, the controller may be configured to open the first switch and close the second switch based on receiving a user input for selecting a first rated voltage, and close the first switch and open the second switch based on receiving a user input for selecting a second rated voltage greater than the first rated voltage.

According to one aspect of the disclosure, an induction heating apparatus capable of adapting to a rated voltage without changing a circuit configuration can be manufactured.

According to one aspect of the disclosure, a need to redesign a resonant circuit according to a rated voltage can be eliminated.

According to one aspect of the disclosure, the manufacturing cost of an induction heating apparatus can be reduced.

### DESCRIPTION OF DRAWINGS

FIG. 1 is a diagram illustrating the appearance of an induction heating apparatus according to an embodiment.

FIGS. 2 and 3 are diagrams for describing a heating principle of an induction heating apparatus according to an embodiment.

FIG. 4 is a diagram illustrating an example of a resonant circuit according to an embodiment.

FIG. 5 is a flowchart showing a method of method of manufacturing an induction heating apparatus according to an embodiment.

FIG. 6 is a diagram illustrating an example of a resonant circuit of a first induction heating apparatus manufactured by a method of manufacturing an induction heating apparatus according to an embodiment.

FIGS. 7 and 8 are diagrams illustrating examples of a resonant circuit of a second induction heating apparatus manufactured by a method of manufacturing an induction heating apparatus according to an embodiment.

FIG. 9 is a diagram illustrating an example of the appearance of a printed circuit board on which a resonant circuit is formed according to an embodiment.

FIG. 10 is a diagram illustrating an example of a resonant circuit of an induction heating apparatus according to an embodiment.

FIG. 11 is a block diagram illustrating a configuration of an induction heating apparatus according to an embodiment.

FIG. 12 is a flowchart showing a method of controlling an induction heating apparatus according to an embodiment.

FIG. 13 is a diagram illustrating a resonant circuit of an induction heating apparatus according to an embodiment that is changed to a state corresponding to a first rated voltage.

FIG. 14 is a diagram illustrating a resonant circuit of an induction heating apparatus according to an embodiment that is changed to a state corresponding to a second rated voltage.

FIG. 15 is a diagram illustrating the appearance of an induction heating apparatus according to an embodiment.

### MODES OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

The terms used herein are for the purpose of describing the embodiments and are not intended to restrict and/or to limit the present disclosure.

For example, the singular expressions herein may include plural expressions, unless the context clearly dictates otherwise.

In addition, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another.

The terms, such as “— part”, “—device”, “—block”, “—member”, “—P module”, and the like may refer to a unit for processing at least one function or act. For example, the terms may refer to at least process processed by at least one hardware, such as field-programmable gate array (FPGA)/application specific integrated circuit (ASIC), software stored in memories, or processors.

Hereinafter, an embodiment of the disclosed disclosure will be described in detail with reference to the accompanying drawings. Identical symbols or numbers in the drawings of the present disclosure denote components or elements configured to perform substantially identical functions.

Hereinafter, the working principle and embodiments of the present disclosure will be described with reference to the accompanying drawings.

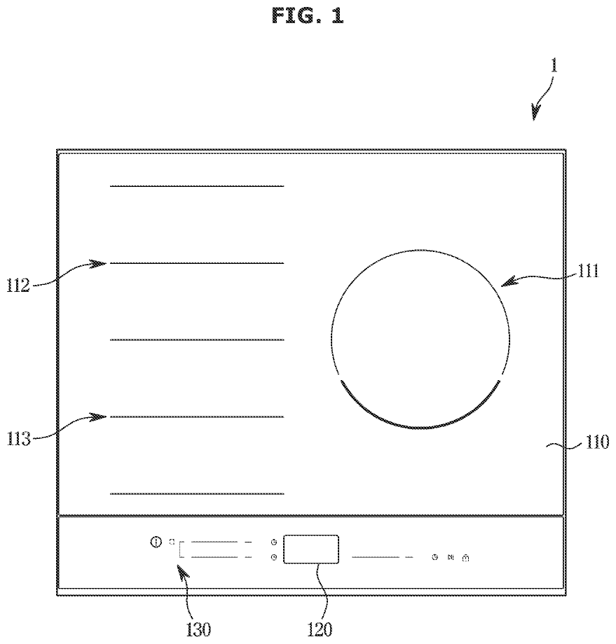

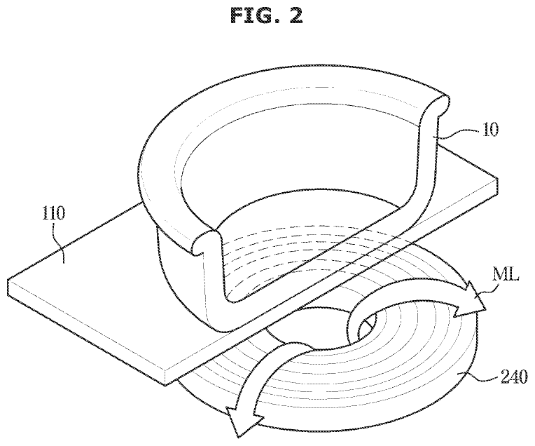

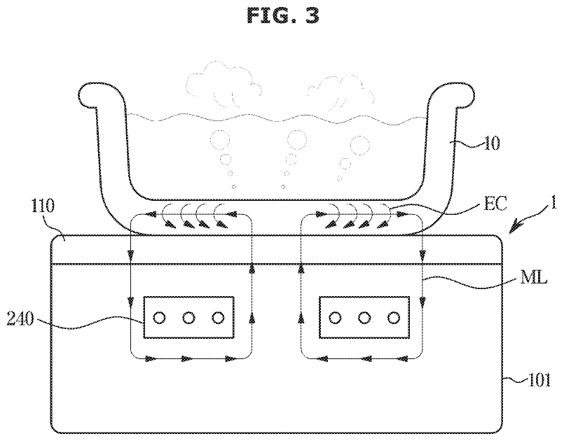

FIG. 1 is a diagram illustrating the appearance of an induction heating apparatus according to an embodiment, and FIGS. 2 and 3 are diagrams for describing a heating principle of an induction heating apparatus according to an embodiment.

In FIG. 1, a top view of an induction heating apparatus 1 according to an embodiment is illustrated. Referring to FIG. 1, the induction heating apparatus 1 according to an embodiment may include a plate 110 provided on an upper portion of a main body 101, cooking zones 111, 112, and 113 formed on the plate 110, and user interfaces 120 and 130 serving as input/output devices. For example, the plate 110 may be implemented with ceramic.

The cooking zones 111, 112, and 113 may represent positions in which the cooking vessels may be placed, and may be indicated in a circular shape (denoted by a reference numeral 111) or in a straight boundary line (denoted by reference numerals 112 and 113) to guide proper arrangement of the cooking vessels.

However, the above-described shapes are only examples of shapes for representing the cooking zones 111, 112, and 113, and without being limited to a circular or straight shape, various shapes may be applied to embodiments of the induction heating apparatus 1 as long as it can guide the user to the position of the cooking zone.

In addition, the present example is illustrated as having three cooking zones on the plate 110, but the embodiment of the induction heating apparatus 1 is not limited thereto. Only one cooking zone may be formed, and four or more cooking zones may be formed.

In one area of the plate 110, a display 140 and an input device 145 may be provided. The display 140 may include a display device, such as an liquid crystal display (LCD) or a light emitting diode (LED), and the input device 145 may include at least one of various input devices, such as a touch pad, a button, or a jog shuttle. Alternatively, the display 140 and the input device 145 may be implemented as a touch screen.

In the present example, a case in which the display 140 and the input device 145 are provided at positions spaced apart from the cooking zones 111, 112, and 113 on the plate 110 is illustrated. However, the arrangement shown in FIG. 1 is only an example applicable to the induction heating apparatus 1, and the display 140 or input device 145 may be placed at a position other than on the plate 110, such as the front of a heating cooking device 100.

Referring to FIGS. 2 and 3 in conjunction with FIG. 1, a heating coil 240 used to heat the vessel 10 placed on the plate 110 may be disposed below the plate 110. For the sake of convenience of description, only one heating coil 240 is illustrated in FIGS. 2 and 3, but the heating coil 240 may be provided corresponding in number to the number of cooking zones.

When three cooking zones 111, 112, and 113 are provided as shown in the example of FIG. 1, the heating coil 240 may be provided as three heating coils 240, and each of the heating coils 240 may be placed on a lower side of a corresponding one of the cooking zones 111, 112, and 113.

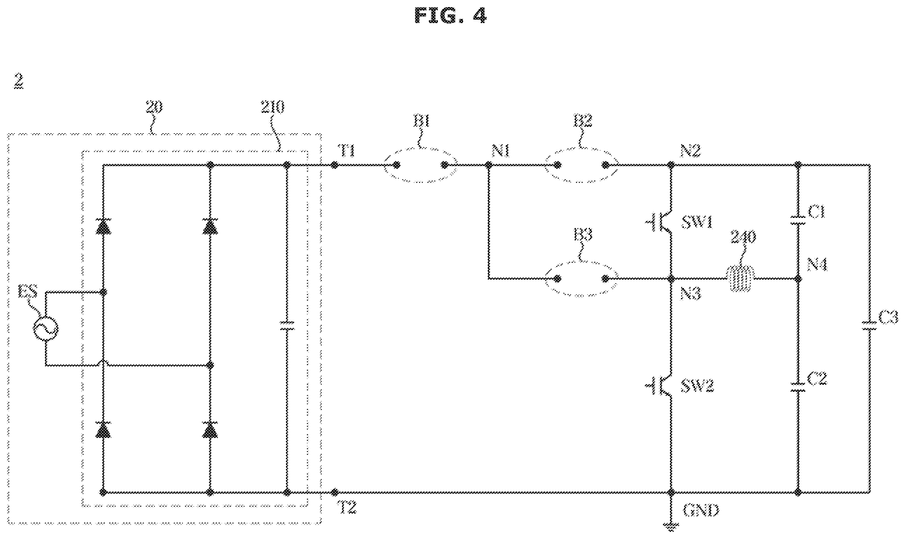

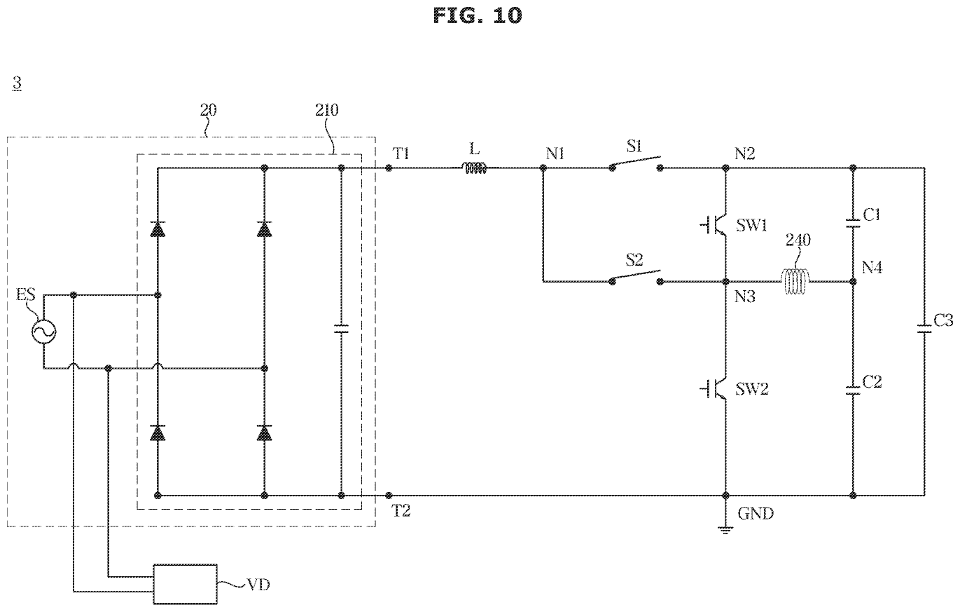

The heating coil 240 may be connected to a resonant circuit (2 or 3 in FIG. 4 or 10) to be described below, and may be supplied with a high-frequency current from the resonant circuit 2 or 3. For example, the frequency of the high frequency current may be in a range of 20 kHz to 35 kHz.

When the heating coil 240 is supplied with a high frequency current, lines of magnetic force ML may be formed in or about the heating coil 240. When the vessel 10 having resistance is located within a range which the lines of magnetic force ML reach, the lines of magnetic force ML around the heating coil 240 may pass through the bottom of the vessel 10, generating an induced current in the form of a vortex according to the law of electromagnetic induction, that is, eddy currents (EC).

The eddy current EC may interact with the electrical resistance of the vessel 10, generating heat in or on the vessel 10, and the generated heat may heat the food inside the vessel 10.

In the induction heating apparatus 1, the vessel 10 itself acts as a heat source, and a metal having a resistance of a certain level or higher, such as iron, stainless steel, or nickel, may be used as a material of the vessel 10.

On the other hand, the specifications of the heating coil 240 may be designed to vary according to the rated voltage of the country in which the induction heating apparatus 1 is sold.

FIG. 4 is a diagram illustrating an example of a resonant circuit according to an embodiment.

Referring to FIG. 4, a resonant circuit 2 may include a power supply module 20.

The power supply module 20 may include a power supply ES and a rectifier 210.

The power supply ES is an AC power supply ES, and may provide a power supply ES corresponding to a rated voltage.

For example, the power supply ES may be an alternating current (AC) power supply having a first rated voltage, or an AC power supply having a second rated voltage.

In this case, the first rated voltage and the second rated voltage are different from each other, and satisfy a condition that the first rated voltage is less than the second rated voltage. For example, the first rated voltage may correspond to a range of 100V to 120V, and the second rated voltage may correspond to a range of 220V to 240V, but examples of the first rated voltage and the second rated voltage are not limited thereto.

Hereinafter, for the sake of convenience of description, it is assumed that the first rated voltage corresponds to 110V and the second rated voltage corresponds to 220V.

The rectifier 210 may convert the AC voltage supplied from the power supply ES into a DC voltage.

To this end, the rectifier 210 may include a bridge rectifier circuit including a plurality of diodes. For example, the bridge rectifier circuit may include four diodes. The diodes may form two pairs of diodes, each pair of diodes obtained by connecting diodes in series, and the two pairs of diodes may be connected in parallel with each other. The bridge diode may convert an AC voltage, of which the polarity changes over time, into a voltage, of which the polarity is constant, and convert an AC current, of which the direction changes over time, into a current, of which the direction is constant.

In addition, the rectifier 210 may include a direct current (DC) link capacitor. The DC link capacitor may convert a voltage of which the magnitude changes over time into a DC voltage of a constant size. The DC link capacitor may maintain the converted DC voltage and provide the DC voltage to an inverter circuit SW1 and SW2. In this case, the inverter circuit SW1 and SW2 may include a first switching element SW1 and a second switching element SW2.

The first switching element SW1 and the second switching element SW2 may operate in a complementary manner to allow an alternating current to flow through the heating coil 240.

The first switching element SW1 and the second switching element SW2 may be implemented as a three-terminal semiconductor device switch having a fast response speed so as to be turned on/off at a high speed. For example, the first switching element SW1 and the second switching element SW2 may be provided as a bipolar junction transistor (BJT), a metal-oxide-semiconductor field effect transistor (MOSFET), an insulated gate bipolar transistor (IGBT) or a thyristor.

The first switching element SW1 and the second switching element SW2 may be turned on/off by switch driving signals. In this case, the switch driving signals may be provided by a controller 150, and the controller 150 may alternately turn on/off the first switching element SW1 and the second switching element SW2, thereby supplying the heating coil 240 with a high-frequency alternating current.

According to various embodiments, the resonant circuit 2 may further include a filter that removes noise components included in the power supplied from the power supply ES. The filter may be composed of a transformer and a capacitor to remove noise mixed with power supplied from the power supply ES, and provide AC power from which noise has been removed to the rectifier 210.

The power supply module 20 may have a first terminal T1 and a second terminal T2.

According to a DC voltage supplied from the power supply module 20, a potential difference may be formed between the first terminal T1 and the second terminal T2. That is, AC power supply ES may be applied to the first terminal T1 and the second terminal T2.

The potential difference formed between the first terminal T1 and the second terminal T2 may be defined as an input voltage, and the fact that the input voltage has a positive (+) value may be taken to mean that the first terminal T1 has a potential higher than that of the second terminal T2, and the fact that the input voltage has a negative (−) value may be taken to mean that the second terminal T2 has a potential higher than that of the first terminal T1.

The resonant circuit 2 may include a first node N1, a second node N2, a third node N3, and a fourth node N4.

A first bypass part B1 may be formed between the first terminal T1 and the first node N1.

A second bypass part B2 may be formed between the first node N1 and the second node N2.

A third bypass part B3 may be formed between the first node N1 and the third node N3.

The first, second, or third bypass part B1, B2, or B3 may refer to a part electrically separating two nodes on a circuit board.

In one embodiment, the first bypass part B1 may include a connection part connected to a side of the first terminal T1 and a connection part connected to a side of the first node N1. Accordingly, the first terminal T1 and the first node N1 may be electrically separated from each other by the first bypass part B1.

The second bypass part B2 may include a connection part connected to a side of the first node N1 and a connection part connected to a side of the second node N2. Accordingly, the first node N1 and the second node N2 may be electrically separated from each other by the second bypass part B2.

The third bypass part B3 may include a connection part connected to a side of the first node N1 and a connection part connected to a side of the third node N3. Accordingly, the first node N1 and the third node N3 may be electrically separated from each other by the third bypass part B3.

The first switching element SW1 may be connected to the second node N2 and the third node N3.

The second switching element SW2 may be connected to the third node N3 and the ground node GND.

The heating coil 240 may be connected between the third node N3 and the fourth node N4.

According to various embodiments, a current sensor for measuring the current applied to the heating coil 240 may be provided between the third node N3 and the fourth node N4.

The second node N2 may refer to a node of a drain terminal (or a collector terminal) of the first switching element SW1.

The third node N3 may refer to a node corresponding to a contact point between the first switching element SW1 and the second switching element SW2. That is, the third node N3 may refer to a node between a source terminal (or an emitter terminal) of the first switching element SW1 and a drain terminal (or a collector terminal) of the second switching element SW2.

The fourth node N4 may refer to a node connected between the first capacitor C1 and the second capacitor C2.

The first capacitor C1 may be connected between the second node N2 and the fourth node N4.

The second capacitor C2 may be connected between the fourth node N4 and the ground node GND.

The third capacitor C3 may be connected between the second node N2 and the ground node GND. In some embodiments, the third capacitor C3 is a removeable capacitor.

Accordingly, the first capacitor C1 and the second capacitor C2 may form a parallel relationship with the third capacitor C3.

The second terminal T2 may be connected to the ground node GND.

Accordingly, the third capacitor C3 may be connected between the second node N2 and the second terminal T2.

A source terminal (or an emitter terminal) of the second switching element SW2 may be connected to the ground node GND. Accordingly, the source terminal (or the emitter terminal) of the second switching element SW2 may be connected to the second terminal T2.

Since the resonant circuit 2 according to an embodiment includes the first bypass part B1, the second bypass part B2, and the third bypass part B3, the manufacturer of the induction heating apparatus 1 may manufacture the induction heating apparatus 1 satisfying different rated voltage conditions by coupling appropriate electronic elements to the first bypass part B1, the second bypass part B2, and the third bypass part B3. Notably, the manufacturer can manufacture the induction heating apparatus 1 without changing the underlying circuitry of the resonant circuit 2.

In this case, the manufacturer may be a person or a machine for coupling the electrical elements.

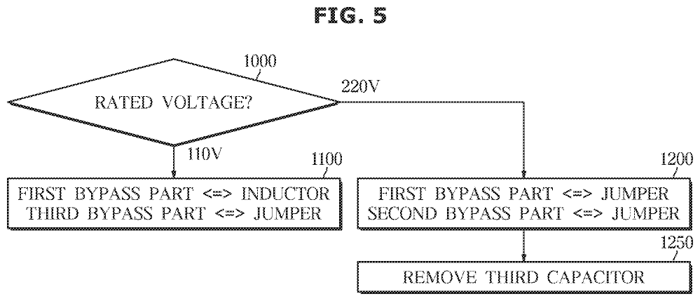

FIG. 5 is a flowchart showing a method of method of manufacturing an induction heating apparatus according to an embodiment.

Referring to FIG. 5, the manufacturer may couple corresponding electronic elements to the first bypass part B1, the second bypass part B2, and the third bypass part B3 according to the rated voltage of the induction heating apparatus 1 to be manufactured.

In one embodiment, when it is intended to manufacture a first induction heating apparatus corresponding to a rated voltage of 110V (110V in operation 1000), the manufacturer may connect an inductor element L to the first bypass part B1 and connect a jumper element J to the third bypass part B3 (1100).

In this case, the inductor element L may refer to an element having inductance. The jumper element J may refer to an element for electrically connecting nodes at both ends of the bypass part. For example, the jumper element J can include a conductive wire and/or conductive jumper cable. The conductive wire and/or conductive jumper cable can include, for example, a metal, a metal alloy, a nonmetal conductive material (e.g., graphite), or a combination thereof.

In addition, when it is intended to manufacture the first induction heating apparatus (110V in operation 1000), the manufacturer may not couple any element to the second bypass part B2. Accordingly, the first node N1 and the second node N2 may be electrically separated from each other.

By connecting the inductor element L to the first bypass part B1 and connecting the jumper element J to the third bypass part B3, the induction heating apparatus 1 corresponding to the first rated voltage (hereinafter referred to as “the first induction heating apparatus”) may be manufactured.

The first induction heating apparatus may refer to an induction heating apparatus 1 capable of producing maximum efficiency when an input voltage of the first rated voltage is applied.

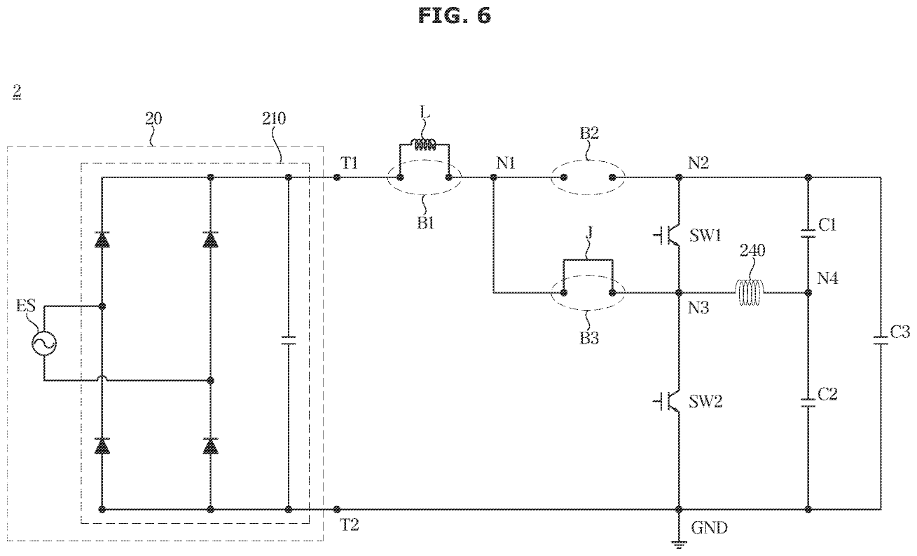

FIG. 6 is a diagram illustrating an example of a resonant circuit 2 of a first induction heating apparatus manufactured by a method of manufacturing an induction heating apparatus according to an embodiment.

Referring to FIG. 6, it can be seen that the inductor element L is connected to the first bypass part B1 and the jumper element J is connected to the third bypass part B3.

The first induction heating apparatus according to an embodiment may include the inductor element L connected to the first terminal T1 and the first node N1, the second bypass part B2 formed in an open state between the first node N1 and the second node N2, and the jumper element J connected to the first node N1 and the third node N3.

As the jumper elements J are connected to the first bypass part B1 and the third bypass part B3, the first node N1 and the third node N3 may be treated as the same node. Accordingly, the third node N3 may be connected to the first terminal T1.

In addition, a heating coil 240 may be connected between the first node N1 (=the third node N3) and the fourth node N4.

The specifications of the heating coil 240 are designed to have maximum efficiency at the second rated voltage.

In the case of the resonant circuit 2 included in the first induction heating apparatus, a circuit in the form of a boost half bridge is formed by the inductor element L and the capacitors. Accordingly, the input voltage may be boosted. As the input voltage is boosted, the output voltage applied to the heating coil 240 may be boosted approximately twice.

Accordingly, even when the input voltage corresponds to the first rated voltage, the heating coil 240 may have maximum efficiency.

According to the present disclosure, the first induction heating apparatus may be manufactured by coupling an appropriate electronic element to the bypass part without changing the configuration of the resonant circuit 2.

Referring back to FIG. 5, in one embodiment, when it is intended to manufacture an induction heating apparatus 1 (hereinafter referred to as a “second induction heating apparatus”) corresponding to the second rated voltage (220V in operation 1000), the manufacturer may connect a jumper element J to the first bypass part B1 and connect a jumper element J to the second bypass part B2 (1200).

According to various embodiments, when it is intended to manufacture the second induction heating apparatus (220V in operation 1000), the manufacturer may remove the third capacitor C3 as needed, in addition to connecting the jumper element J to the first bypass part B1 and connecting the jumper element J to the second bypass part B2 (1250).

In addition, when it is intended to manufacture the second induction heating apparatus (220V in operation 1000), the manufacturer may not couple any element to the third bypass part B3. Accordingly, the first node N1 and the third node N3 may be electrically separated from each other.

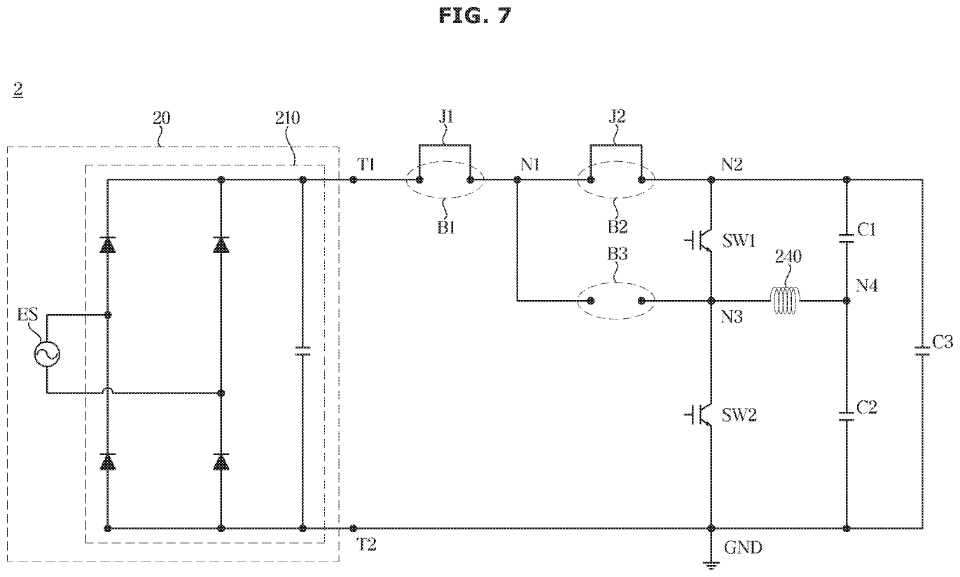

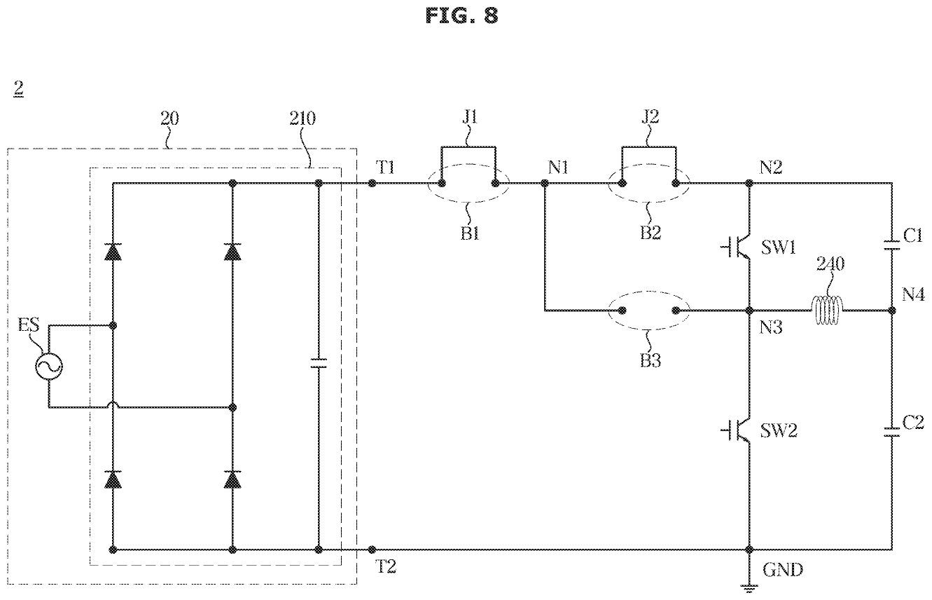

FIGS. 7 and 8 are diagrams illustrating examples of a resonant circuit 2 of a second induction heating apparatus manufactured by a method of manufacturing an induction heating apparatus according to an embodiment.

Referring to FIG. 7, it can be seen that the first jumper element J1 is connected to the first bypass part B1, and the second jumper element J2 is connected to the second bypass part B2.

In one embodiment, the resonant circuit 2 of the second induction heating apparatus may include the first jumper element J1 connecting the first terminal T1 to the first node N1, and the second jumper element J2 connecting the first node N1 to the second node N2. The third bypass part B3 is formed in an open state between the first node N1 and the third node N3.

As the jumper elements J1 and J2 are respectively connected to the first bypass part B1 and the second bypass part B2, the first node N1 and the second node N2 may be treated as the same node. Accordingly, the second node N2 may be connected to the first terminal T1.

The specifications of the heating coil 240 are designed to have maximum efficiency at the second rated voltage.

In the case of the resonant circuit 2 included in the second induction heating apparatus, the input voltage may be fully transferred to the heating coil 240. Accordingly, when the input voltage corresponds to the second rated voltage, the heating coil 240 may have maximum efficiency.

According to the present disclosure, the second induction heating apparatus corresponding to the second rated voltage may be manufactured by coupling an appropriate electronic element to the bypass part without changing the configuration of the resonant circuit 2.

Referring to FIG. 8, it can be seen that the third capacitor C3 has been removed from the resonant circuit 2 shown in FIG. 7.

The third capacitor C3, so called boost capacitor, is used to boost the output voltage applied to the heating coil 240. In some embodiments, the third capacitor C3 is removable. Accordingly, when the input voltage corresponds to the second rated voltage, the third capacitor C3 may be removed as needed.

According to the present disclosure, since the specifications of the heating coil 240 do not need to be changed to suit the rated voltage from those of the previously designed resonant circuit 2, an induction heating apparatus corresponding to a plurality of rated voltages may be manufactured through an appropriate process without circuit change.

In addition, according to the present disclosure, the production cost of the induction heating apparatus 1 may be reduced by manufacturing only heating coils 240 having the same specifications.

To summarize FIGS. 6 to 8, the induction heating apparatus 1 may include a circuit configuration including: the first node N1, the second node N2, the third node N3, and the fourth node N4; the power supply module 20 having the first terminal T1 and the second terminal T2; the first bypass part B1 formed between the first terminal T1 and the first node N1; the second bypass B2 formed between the first node N1 and the second node N2; the third bypass B3 formed between the first node N1 and the third node N3; the first switching element SW1 connected to the second node N2 and the third node N3; the second switching element SW2 connected to the third node N3 and the second terminal T2; and the heating coil 240 connected between the third node N3 and the fourth node N4, wherein according to a rated voltage of the power supply module 20, the inductor element L or the first jumper element J1 is configured to be connected to the first bypass part B1, and the second jumper element J2 is configured to be connected to one selected from the second bypass part B2 or the third bypass part B3.

Meanwhile, the resonant circuit 2 may be formed on the printed circuit board 200.

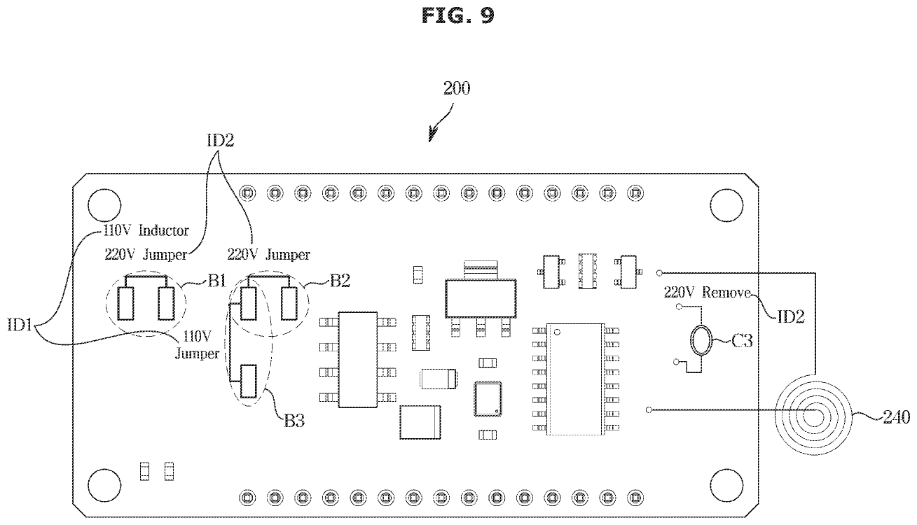

FIG. 9 is a diagram illustrating an example of the appearance of a printed circuit board on which a resonant circuit is formed according to an embodiment.

The printed circuit board 200 according to an embodiment may include at least one visual indicator for guiding assembly of electronic elements.

The printed circuit board 200 may include at least one visual indicator ID1 for guiding a method of manufacturing the first induction heating apparatus and/or at least one visual indicator ID2 for guiding a method of manufacturing the second induction heating apparatus.

The visual indicators ID1 and ID2 may include letters, figures, symbols, numbers, or a combination thereof.

The visual indicator ID1 may be provided adjacent to the first bypass part B1 and the third bypass part B3 on the printed circuit board 200.

The visual indicator ID1 may include a visual indicator for inducing connection of the inductor element L to the first bypass part B1 and a visual indicator for inducing connection of the jumper element J to the third bypass part B3.

The visual indicator ID2 may be provided adjacent to the first bypass part B1 and the second bypass part B2 on the printed circuit board 200.

The visual indicator ID2 may include a visual indicator for inducing connection of the jumper element J to the first bypass part B1 and a visual indicator for inducing connection of the jumper element J to the second bypass part B2.

According to various embodiments, the visual indicator ID2 may be provided adjacent to the third capacitor C3 on the printed circuit board 200.

The visual indicator ID2 may include a visual indicator for inducing removal of the third capacitor C3.

The present disclosure may prevent mistakes in designing the resonant circuit 2 when the manufacturer of the induction heating apparatus 1 is a person rather than a machine.

FIG. 10 is a diagram illustrating an example of a resonant circuit of an induction heating apparatus according to an embodiment.

Referring to FIG. 10, unlike the resonant circuit 2 shown in FIG. 4, a resonant circuit 3 of the induction heating apparatus 1 according to an embodiment may include the inductor element L connected to the first terminal T1 and the first node N1, the first switch S1 provided between the first node N1 and the second node N2, and the second switch S2 provided between the first node N1 and the third node N3.

Configurations identical to those of the resonant circuit 2 described above with reference to FIG. 4 will be omitted.

As to describe the resonant circuit 3 of FIG. 10 in view of the resonant circuit 2 shown in FIG. 4, the resonant circuit 3 has a form in which the inductor element L is connected to the first bypass part B1, the first switch S1 is connected to the second bypass part B2, and the second switch S2 is connected to the third bypass part B3.

In this case, the first switch S1 and the second switch S2 correspond to on/off switches. The first switch S1 and the second switch S2 may be opened and closed according to electrical signals.

The first switch S1 may selectively connect the first node N1 and the second node N2 to each other. For example, when the first switch S1 is opened, the first node N1 and the second node N2 are electrically separated from each other, and when the first switch S1 is closed, the first node N1 and the second node N2 are electrically connected to each other.

The second switch S2 may selectively connect the first node N1 and the third node N3 to each other. For example, when the second switch S2 is opened, the first node N1 and the third node N3 are electrically separated from each other, and when the second switch S2 is closed, the first node N1 and the third node N3 are electrically connected to each other.

The resonant circuit 3 may further include a voltage detector VD for detecting a voltage output from the power supply ES.

Any component (e.g., a voltage sensor) capable of detecting an input voltage may be employed as the voltage detector VD without limitation. In addition, the location of the voltage detector VD may be provided without limitation as long as it is a location capable of detecting the input voltage.

For example, one end of the voltage detector VD may be connected to one end of the power supply ES, and the other end of the voltage detector VD may be connected to the other end of the power supply ES.

As another example, one end of the voltage detector VD may be connected to the first terminal T1, and the other end of the voltage detector VD may be connected to the second terminal T2.

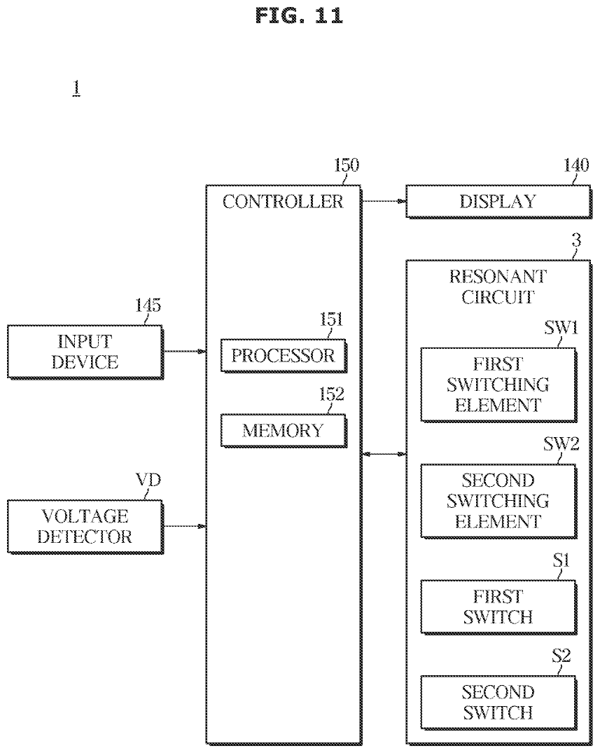

FIG. 11 is a block diagram illustrating a configuration of an induction heating apparatus according to an embodiment.

Referring to FIG. 11, an induction heating apparatus 1 according to an embodiment includes a display 140, an input device 145, a voltage detector VD, a controller 150, and a resonant circuit 3.

The resonant circuit 3 may include a first switching element SW1, a second switching element SW2, a first switch S1, and a second switch S2.

In the induction heating apparatus 1, the controller 150 for controlling the operation of the induction heating apparatus 1 may include at least one memory 152 in which a program for performing an operation described below is stored and at least one processor 151 for executing the stored program.

The at least one processor 151 may include a microprocessor. A microprocessor is a processing device in which an arithmetic logic operator, a register, a program counter, a command decoder, a control circuit, and the like are provided in at least one silicon chip.

The microprocessor may include a graphic processing unit (GPU) for graphic processing of images or videos. The microprocessor may be implemented in the form of a system on chip (SoC) including a core and a GPU. The microprocessor may include a single core, a dual core, a triple core, a quad core, and a core of multiples thereof.

In addition, the at least one processor 151 may include an input/output processor configured to mediate data access between various components included in the induction heating apparatus 1 and the controller 150.

The at least one memory 152 may include a non-volatile memory, such as a read only memory (ROM), a high-speed random access memory (RAM), a magnetic disk storage device, or a flash memory device, or other types of non-volatile semiconductor memory devices.

For example, the at least one memory 152 may be a semiconductor memory device, including one of a Secure Digital (SD) memory card, a Secure Digital High Capacity (SDHC) memory card, a mini SD memory card, a mini SDHC memory card, a Trans Flash (TF) memory card, a micro SD memory card, a micro SDHC memory card, a memory stick, a Compact Flash (CF), a Multi-Media Card (MMC), an MMC micro, and an eXtreme Digital (XD) card.

In addition, the at least one memory 152 may include a network attached storage device that allows an access through a network.

The controller 150 may control the induction heating apparatus 1 according to a user input received through the input device 145. For example, the input device 145 may receive a user input related to power on/off of the power supply ES, selection of cooking zones 111, 112, and 113, selection of a heating intensity of the selected cooking zone(s), setting of a timer, and the like.

For example, the controller 150 may select a heating coil 240 to be supplied with high-frequency power according to a selection of a cooking zone received by the input device 145, and may adjust the intensity of a magnetic field generated by the heating coil 240 according to a selection of the heating intensity received by the input device 145. In configurations having a single cooking zone, a heating intensity may be directly selected without selecting a cooking zone.

When the input device 145 receives a selection for the heating intensity from the user, the controller 150 may determine on/off frequencies of the first switching element SW1 and the second switching element SW1 based on the selected heating intensity. The controller 150 may alternately turn on/off the first switching element SW1 and the second switching element SW1 according to the determined on/off frequency, thereby applying, to the heating coil 240, a high-frequency current having a frequency corresponding to the selected heating intensity.

When the input device 145 receives a selection for starting heating from the user, the controller 150 may control the power supply module 20 such that power of the power supply module 20 is supplied to the resonant circuit 3.

The display 140 may display information about the current state of the induction heating apparatus 1, information for guiding selection of one or more cooking zones and/or heating intensity, and information for guiding timer setting. In addition, the display 140 may display a notification indicating whether a vessel 10 is present.

In one embodiment, the controller may, after controlling the power supply module 20 such that power of the power supply module 20 is supplied to the resonant circuit 3, identify the rated voltage based on the magnitude of the voltage detected by the voltage detector VD.

In addition, the controller may control the first switch S1 and the second switch S2 based on the magnitude of the voltage detected by the voltage detector VD.

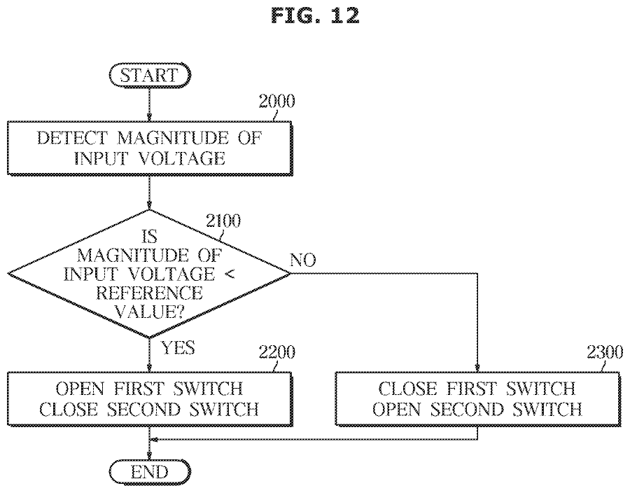

FIG. 12 is a flowchart showing a method of controlling an induction heating apparatus according to an embodiment.

Referring to FIG. 12, when the power supply ES is applied to the resonant circuit 3, the voltage detector VD may detect the magnitude of an input voltage output from the power supply ES (2000).

After that, the voltage detector VD may transmit information about the magnitude of the voltage to the controller.

The controller may, based on the magnitude of the voltage detected by the voltage detector VD being less than a reference value (YES in operation 2100), open the first switch S1 and close the second switch S2 (2200).

In this case, the reference value is a value for distinguishing the first rated voltage and the second rated voltage, and may be stored in the memory 152 in advance.

For example, the reference value may be set to about 200V.

After the power supply ES is applied to the resonant circuit 3, the magnitude of the voltage detected by the voltage detector VD being less than the reference value may identify that the rated voltage corresponds to the first rated voltage.

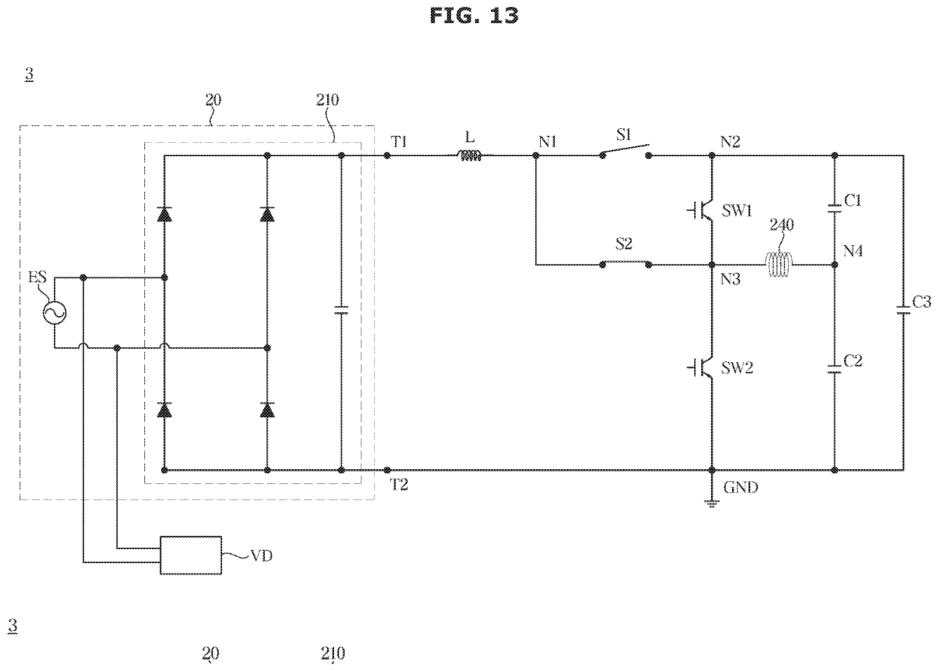

FIG. 13 is a diagram illustrating a resonant circuit of an induction heating apparatus according to an embodiment that is changed to a state corresponding to the first rated voltage.

Referring to FIG. 13, it can be seen that based on the magnitude of the voltage detected by the voltage detector VD being less than the reference value, subsequent to the power ES being applied to the resonant circuit 3, the first switch S1 is opened and the second switch S2 is closed.

In response to the first switch S1 being opened and the second switch S2 being closed, the first node N1 is treated as the same node as the third node N3, and the first node N1 and the second node N2 are electrically separated from each other.

In response to the first switch S1 being opened and the second switch S2 being closed, a circuit in the form of a boost half bridge is formed by the inductor element L and the capacitors. Accordingly, the input voltage may be boosted. As the input voltage is boosted, the output voltage applied to the heating coil 240 may be boosted approximately twice.

As described above, the specifications of the heating coil 240 are designed to have maximum efficiency at the second rated voltage.

Accordingly, even when the input voltage corresponds to the first rated voltage, the heating coil 240 may have maximum efficiency.

Meanwhile, the controller may, based on the magnitude of the voltage detected by the voltage detector VD being greater than the reference value (NO in operation 2100), close the first switch S1 and open the second switch S2 (2300).

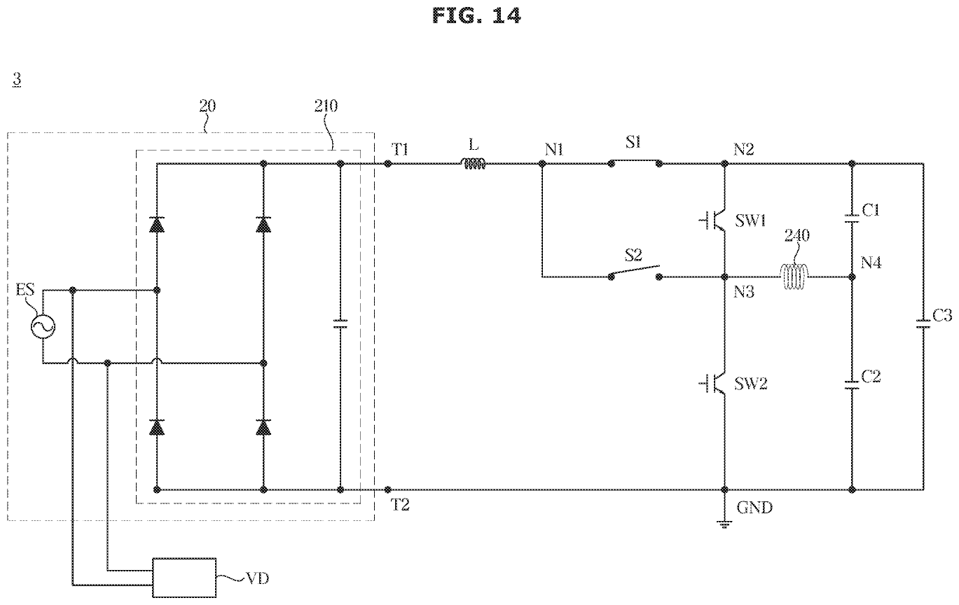

FIG. 14 is a diagram illustrating a resonant circuit of an induction heating apparatus according to an embodiment that is changed to a state corresponding to a second rated voltage.

Referring to FIG. 14, it can be seen that based on the magnitude of the voltage detected by the voltage detector VD being greater than the reference value, subsequent to the power supply ES being applied to the resonant circuit 3, the first switch S1 is closed and the second switch S2 is opened.

As described above, the specifications of the heating coil 240 are designed to have maximum efficiency at the second rated voltage.

Accordingly, when the input voltage corresponds to the second rated voltage, the heating coil 240 may have maximum efficiency.

According to the present disclosure, the induction heating apparatus 1 may have compatibility between the first rated voltage and the second rated voltage by controlling the switches S1 and S2 without changing the configuration of the resonant circuit 2.

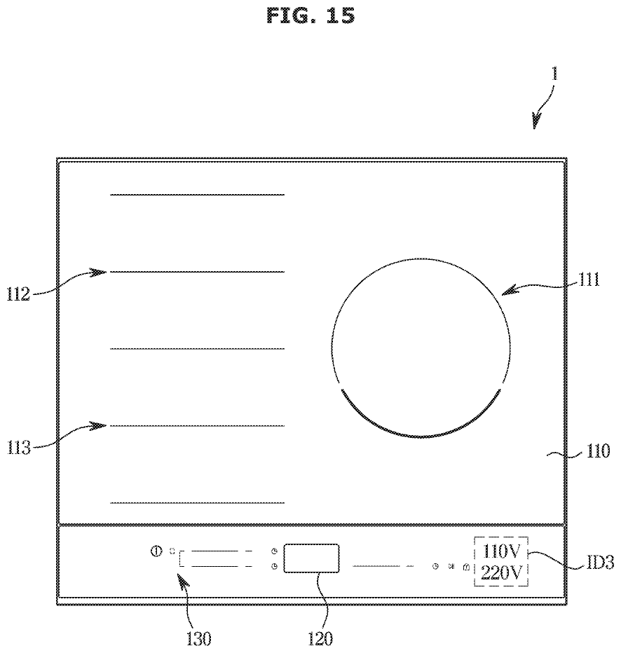

FIG. 15 is a diagram illustrating the appearance of an induction heating apparatus according to an embodiment.

Referring to FIG. 15, the user interfaces 120 and 130 of the induction heating apparatus 1 according to an embodiment may receive a user input for selecting a rated voltage.

To this end, the user interfaces 120 and 130 may provide a visual indicator ID3 for inducing selection of a user input for selecting a rated voltage.

A user may select a rated voltage to be used through the user interfaces 120 and 130.

For example, the user may select the first rated voltage by touching a portion corresponding to the first rated voltage on the visual indicator ID3 for a preset time.

In addition, the user may select the second rated voltage by touching a portion corresponding to the second rated voltage on the visual indicator ID3 for a preset time.

According to various embodiments, the controller may, based on receiving a user input for selecting the first rated voltage, open the first switch S1 and close the second switch S2.

In addition, the controller may, based on receiving a user input for selecting the second rated voltage, close the first switch S1 and open the second switch S2.

According to the embodiment of controlling the switches S1 and S2 based on a user input, the voltage detector VD may be omitted from the resonant circuit 3.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

In addition, the computer-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the present disclosure have been described with reference to the accompanying drawings, those skilled in the art will appreciate that these inventive concepts may be embodied in different forms without departing from the scope and spirit of the disclosure, and should not be construed as limited to the embodiments set forth herein.

1. An induction heating apparatus comprising:
a circuit configuration including:
a first node, a second node, a third node, and a fourth node;
a power supply module having a first terminal and a second terminal;
a first bypass part formed between the first terminal and the first node;
a second bypass part formed between the first node and the second node;
a third bypass part formed between the first node and the third node;
a first switching element connected to the second node and the third node;
a second switching element connected to the third node and the second terminal; and
a heating coil connected between the third node and the fourth node,
wherein according to a rated voltage of the power supply module, one of an inductor element and a first jumper element is configured to be connected to the first bypass part, and a second jumper element is configured to be connected to one selected from the second bypass part and the third bypass part.

2. The induction heating apparatus of claim 1, wherein the rated voltage is a first rated voltage or a second rated voltage, and the first rated voltage is lower than the second rated voltage.

3. The induction heating apparatus of claim 2, wherein in response to the rated voltage being the first rated voltage, the inductor element is configured to be connected to the first bypass part, and the second jumper element is configured to be connected to the third bypass part from between the first node and the third node.

4. The induction heating apparatus of claim 2, wherein in response to the rated voltage being the second rated voltage, the first jumper element is configured to be connected to the first bypass part, and the second jumper element is configured to be connected to the second bypass part from between the first node and the second node.

5. The induction heating apparatus of claim 1, further comprising:
a first capacitor connected between the second node and the fourth node; and
a second capacitor connected to the fourth node and the second terminal.

6. The induction heating apparatus of claim 5, wherein the circuit configuration selectively includes a third capacitor configured to connect the second node to the second terminal according to the rated voltage of the power supply module.

7. The induction heating apparatus of claim 6, wherein in response to the rated voltage being the first rated voltage, the circuit configuration includes the third capacitor, and in response to the rated voltage being the second rated voltage greater than the first rated voltage, the circuit configuration excludes the third capacitor.

8. The induction heating apparatus of claim 1, wherein the circuit configuration is formed on a printed circuit board (PCB).

9. The induction heating apparatus of claim 8, wherein the PCB includes at least one visual indicator for guiding a method of manufacturing the induction heating apparatus corresponding to the rated voltage.

10. The induction heating apparatus of claim 1, wherein the power supply module includes a rectifier connected to an alternating current (AC) power supply, and
a direct current (DC) voltage rectified by the rectifier is applied to the first terminal.

11. The induction heating apparatus of claim 1, wherein the second terminal is connected to a ground node.

12. An induction heating apparatus comprising:
a first node, a second node, a third node, and a fourth node;
a power supply module having a first terminal and a second terminal;
an inductor element connected to the first terminal and the first node;
a jumper element connecting the first node to the third node;
a first switching element connected to the second node and the third node;
a second switching element connected to the third node and the second terminal;
a heating coil connected between the third node and the fourth node;
a first capacitor connected to the second node and the fourth node;
a second capacitor connected to the fourth node and the second terminal; and
a third capacitor connected to the second node and the second terminal.

13. An induction heating apparatus comprising:
a first node, a second node, a third node, and a fourth node;
a power supply module having a first terminal and a second terminal;
a first jumper element connecting the first terminal to the first node;
a second jumper element connecting the first node to the second node;
a first switching element connected to the second node and the third node;
a second switching element connected to the third node and the second terminal;
a heating coil connected between the third node and the fourth node;
a first capacitor connected to the second node and the fourth node; and
a second capacitor connected to the fourth node and the second terminal.

14. An induction heating apparatus comprising:
a first node, a second node, a third node, and a fourth node;
a power supply module having a first terminal and a second terminal;
an inductor element connected to the first terminal and the first node;
a first switch selectively connecting the first node to the second node;
a second switch selectively connecting the first node to the third node;
a first switching element connected to the second node and the third node;
a second switching element connected to the third node and the second terminal;
a heating coil connected between the third node and the fourth node;
a first capacitor connected to the second node and the fourth node;
a second capacitor connected to the fourth node and the second terminal;
a third capacitor connected to the second node and the second terminal;
a voltage detector configured to detect an output voltage of the power supply module; and
a controller configured to control the first switch and the second switch based on a magnitude of the voltage detected by the voltage detector.

15. The induction heating apparatus of claim 14, wherein the controller is configured to:
open the first switch and close the second switch based on the magnitude of the voltage detected by the voltage detector being smaller than a reference value; and
close the first switch and open the second switch based on the magnitude of the voltage detected by the voltage detector being greater than the reference value.

16. An induction heating apparatus comprising:
a first node, a second node, a third node, and a fourth node;
a power supply module having a first terminal and a second terminal;
a first bypass part formed between the first terminal and the first node;
a second bypass part formed between the first node and the second node;
a third bypass part formed between the first node and the third node; and
a heating coil connected between the third node and the fourth node.
